(19) United States
(12) Patent Application Publication
(10) Pub. No.: US 2025/0270107 A1
(43) Pub. Date: Aug. 28, 2025

(54) ZIRCON TYPE AB04 MATERIALS AS MAGNESIUM CATHODES

(71) Applicant: The Regents of the University of California, Oakland, CA (US)

(72) Inventors: Kristin A. Persson, Orinda, CA (US); Gerbrand Ceder, Orinda, CA (US); Ann C. Rutt, Berkeley, CA (US); Jimmy-Xuan Shen, Oakland, CA (US); Dogancan Sari, Albany, CA (US); Jiyoon Kim, Walnut Creek, CA (US); Qian Chen, Emeryville, CA (US)

(21) Appl. No.: 18/575,085

(22) PCT Filed: Jun. 30, 2022
(86) PCT No.: PCT/US2022/073315

§ 371 Date: Dec. 28, 2023

Related U.S. Application Data
(60) Provisional application No. 63/217,190, filed on Jun. 30, 2021.

(51) Int. Cl. C01G 37/00; C01G 31/00; H01M 4/485; H01M 10/054

(52) U.S. Cl. CPC C01G 37/006; C01G 31/006; H01M 4/485; H01M 10/054; C01P 2002/72; C01P 2002/76; C01P 2002/77; C01P 2006/40

(57) ABSTRACT

A composition MxABO₄ can include: a composition ABO₄, wherein M is selected from the group consisting of: Ca, Mg, and Na, wherein M is intercalated with ABO₄, wherein x is greater than or equal to 0, wherein A includes at least one selected from the group consisting of: Dy, Er, Sm, Nd, Tm, Pr, Gd, Sc, Y, Eu, Ho, Tb, Bi, Lu, La, Yb, Ce, Zr, Hf, Th, U, Ce, In, Tl, Pa, Pu, Ba, Pb, and Sr, wherein B includes at least one selected from the group consisting of: B, P, V, Cr, As, Si, Ge, N, Nb, Mo, Ru, Sb, W, Re, Bi, Mn, Fe, Se, Tc, Sn, and Co, and wherein the composition ABO₄ has a tetragonal structure.

### CROSS REFERENCE TO RELATED APPLICATION

The present application claims priority to U.S. provisional Application No. 63/217,190, entitled “ZIRCON TYPE AB04 MATERIALS AS MAGNESIUM CATHODES”, filed on Jun. 30, 2021. The entire contents of the above-listed application are hereby incorporated by reference for all purposes.

### TECHNICAL FIELD

This disclosure is directed to the use of compositions for cathodes, namely Mg, Ca, and Na cathodes.

### BACKGROUND

The rapid growth of portable consumer electronics and electric vehicles demands new battery technologies with greater energy stored at a reduced cost. Energy storage solutions based on multivalent metals, such as Mg, could significantly increase the energy density as compared to lithium ion based technology. Density functional theory calculations may be employed to systematically evaluate the performance, such as thermodynamic stability, ion diffusivity and voltage, of a group of zircon compounds for Mg/Ca/Na cathode applications. Based on calculations, EuCro₄, YCrO₄, YVO₄ zircon compounds exhibit excellent Mg2+ mobility (diffusion activation energy 107, 121, and 71 meV). Electrochemical response of EuCro₄, YCrO₄, YVO₄ and ScVO₄ zircon compounds were observed in Mg ion batteries. Ca2+ and Na⁺ intercalating into YVO₄ exhibits a low diffusion activation barrier of 62 and 78 meV, revealing a potential cathode for use in Ca and Na rechargeable batteries.

It has been a challenge to find high performance Mg cathodes with good Mg solid state mobility. Unsuitable Mg cathodes has been a limiting factor in realizing high performance Mg batteries that can fulfill the needs of energy storage applications such as electric vehicles. Spinel MgTi2S4 is the current leading Mg cathode with a theoretical capacity of 224 mAh/g, an experimentally measured voltage of 1.2 V vs. Mg²⁺/Mg, and a theoretically predicted migration barrier of 615 meV. However, a need remains for improved cathodes.

### BRIEF DESCRIPTION

The inventors herein have developed systems and methods which at least partially address the above identified issues. In a first embodiment, a composition MxABO₄ for a cathode is formed that includes: a composition ABO₄, wherein M is selected from the group consisting of: Ca, Mg, and Na, wherein M is intercalated with ABO₄, wherein x is greater than or equal to 0, wherein A includes at least one selected from the group consisting of: Dy, Er, Sm, Nd, Tm, Pr, Gd, Sc, Y, Eu, Ho, Tb, Bi, Lu, La, Yb, Ce, Zr, Hf, Th, U, Ce, In, Tl, Pa, Pu, Ba, Pb, and Sr, wherein B includes at least one selected from the group consisting of: B, P, V, Cr, As, Si, Ge, N, Nb, Mo, Ru, Sb, W, Re, Bi, Mn, Fe, Se, Tc, Sn, and Co, and wherein the composition ABO₄ has a tetragonal structure.

In certain embodiments, M is Mg made using a solid state method and the composition ABO₄ is either EuCrO₄, EuVO₄, YVO₄, or ScVO₄. In other alternative embodiments, M is Mg made using a sol-gel method and the composition ABO₄ is either EuCrO₄, EuVO₄, or YVO₄.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present disclosure will be better understood from reading the following description of non-limiting embodiments, with reference to the attached drawings, wherein below:

FIG. 1 illustrates an example of the crystal structure of EuCrO₄ in accordance with certain implementations of the disclosed technology.

FIG. 2 illustrates an example of the structure of the Zircon family/host in accordance with certain implementations of the disclosed technology.

FIG. 3 illustrates an example of the structure of the Zircon family/intercalated in accordance with certain implementations of the disclosed technology.

FIG. 4 illustrates an example in which NEB showed low energy barrier in accordance with certain implementations of the disclosed technology.

FIG. 5 illustrates an example of probability density analysis for the Ca migration pathway in CaₓYVO₄ from ab initio molecular dynamics calculations in accordance with certain implementations of the disclosed technology.

FIG. 6 illustrates an example of CaₓYVO₄ diffusivity in accordance with certain implementations of the disclosed technology.

FIG. 7 illustrates an example of five different compositions that were tried with solid-state synthesis, four of which were synthesized with high purity in accordance with certain implementations of the disclosed technology.

FIG. 8 illustrates an example of electrochemical response of Zircon compounds observed in Mg ion batteries in accordance with certain implementations of the disclosed technology.

FIG. 9 illustrates an example of three compositions synthesized with sol-gel method in accordance with certain implementations of the disclosed technology.

FIG. 10 illustrates an example of electrochemical response of Zircon compounds observed in Mg ion batteries in accordance with certain implementations of the disclosed technology.

### DETAILED DESCRIPTION

Implementations of the disclosed technology are generally directed to improved Mg, Ca, and Na cathodes.

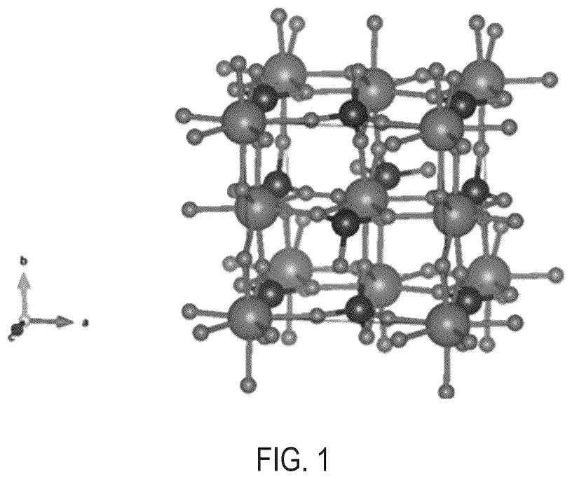

FIG. 1 illustrates an example of crystal structure of EuCro₄ demonstrating the structure type of the zircon-type ABO4 family in accordance with certain implementations of the disclosed technology.

Implementations of the disclosed technology present a significant improvement over current Mg cathodes with respect to improved Mg solid state mobility. Theoretical predictions using density functional theory have found the Mg migration barrier to be much lower in materials in the zircon-type ABO4 family: EuCro4, YCrO4 and YVO4 and comparable voltage, capacity and energy density to other Mg cathodes. Therefore, the disclosed invention offers an attractive alternative to currently available Mg cathodes. The YVO₄ compound showed low diffusion barriers for Mg, Ca and Na, suggesting this compound family to be a promising cathode material in Mg/Ca/Na ion batteries.

Table 1 illustrates information pertaining to multiple compositions that were studied.

TABLE 1

| | Working | Redox | Energy barrier | Experimentally |
|---|---|---|---|---|
| Host | ion | center | (meV) | investigated |
| EuCrO₄ | Mg | Cr | 107 | Yes |
| YCrO₄ | Mg | Cr | 121 | Yes |
| YVO₄ | MG/Ca/NA | V | 71/62/78 | Yes |
| EuVO4 | Mg | V | — | Yes |
| ScVO4 | Mg | V | — | Yes |

Table 2 illustrates comparisons to other Mg/Ca cathodes.

TABLE 2

| | | | Other ones | | | |
|---|---|---|---|---|---|---|
| | Ours | | Spinel | Layered | Chevrel | NASICON |
| | MgₓCrO₄ | CaₓYVO₄ | MgₓTi₂S₄ | MgₓTiS₂ | MgₓMo₆S₈ | Caₓ[NaV₂(PO₄)₃ |
| Avg. | 2.1 V | 0.8 V | 0.89 | 1.2 | 0.99 | 3.2 |
| Voltage | | | | | | |
| (theory) | | | | | | |
| Gravimetric | 96 | 119 | 224 | 239 | 129 | 81 |
| Capacity | | | | | | |
| (mAh/g) | | | | | | |
| Gravimetric | 198 | 240 | 199 | 287 | 128 | 259 |
| Energy | | | | | | |
| Density | | | | | | |
| (Wh/kg) | | | | | | |
| Migration | 107 | 62 | 615 | 1160 | 500 | — |
| Barrier | | | | | | |
| (meV) | | | | | | |

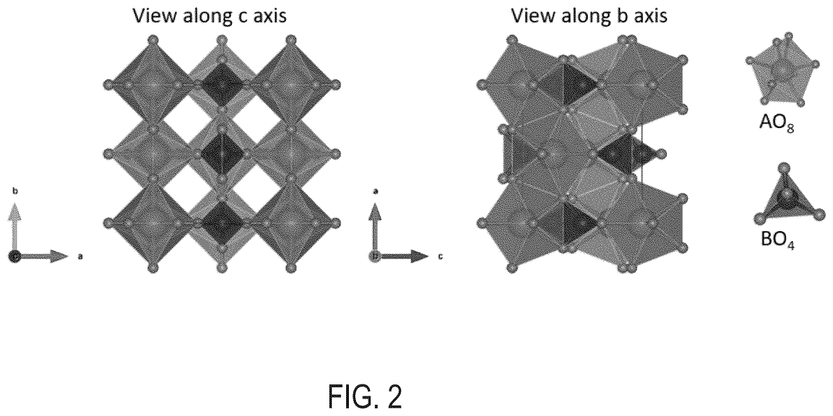

FIG. 2 illustrates an example of the structure of the Zircon family/host where ABO₄ with edge-sharing AO₈ dodecahedral and BO₄ tetrahedral and structure type: tetragonal (I4_1/amd).

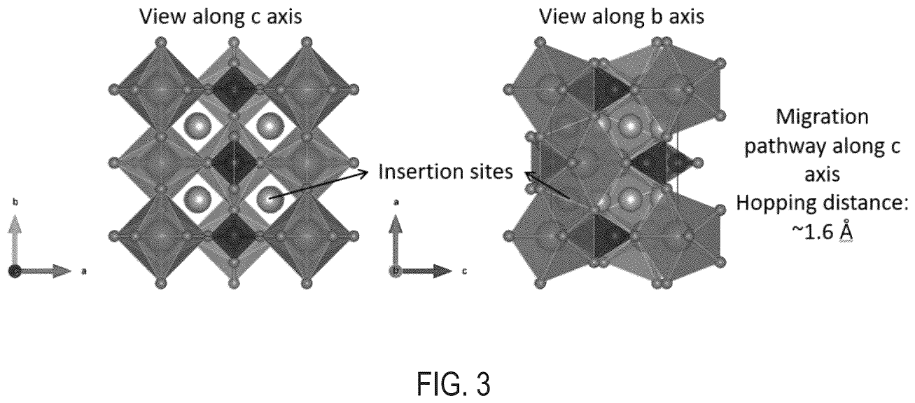

FIG. 3 illustrates an example of the structure of the Zircon family/intercalated where MₓABO4, M=Mg, Ca, Na and Ab initio calculations confirmed stable structures with Mg/Ca/Na inserted. As used herein, the term intercalated generally refers to the Ca, Mg, or Na are inserted into the ABO₄ structure during chemical or electrochemical reactions.

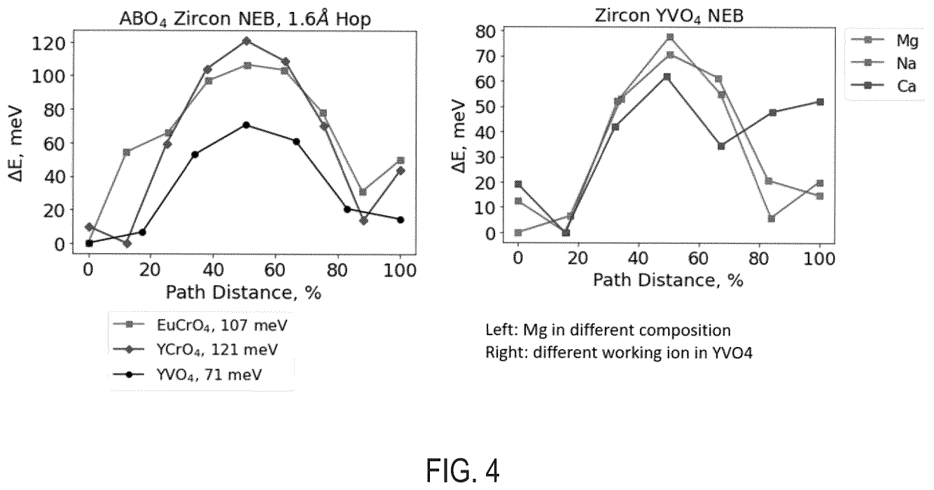

FIG. 4 illustrates an example in which NEB calculations showed low energy barrier.

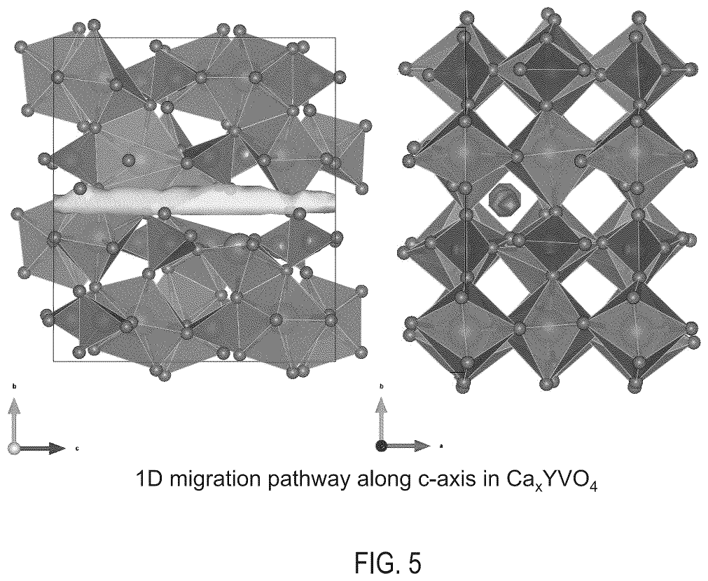

FIG. 5 illustrates an example of probability density analysis for the Ca migration pathway in CaₓYVO₄ from ab initio molecular dynamics calculations.

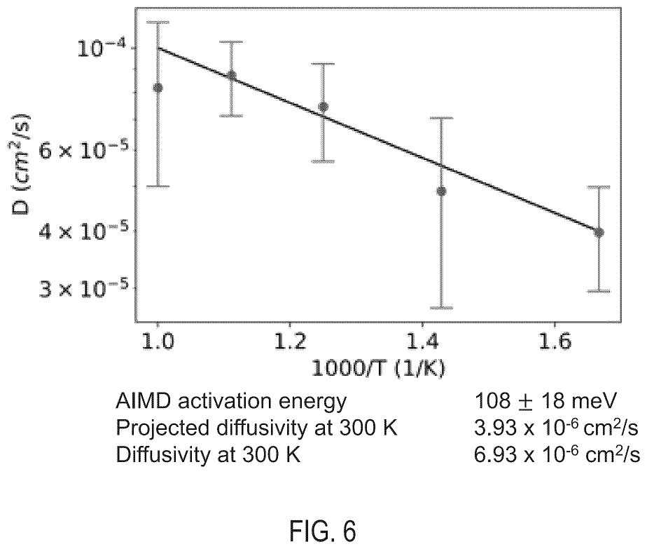

FIG. 6 illustrates an example of CaₓYVO₄ diffusivity.

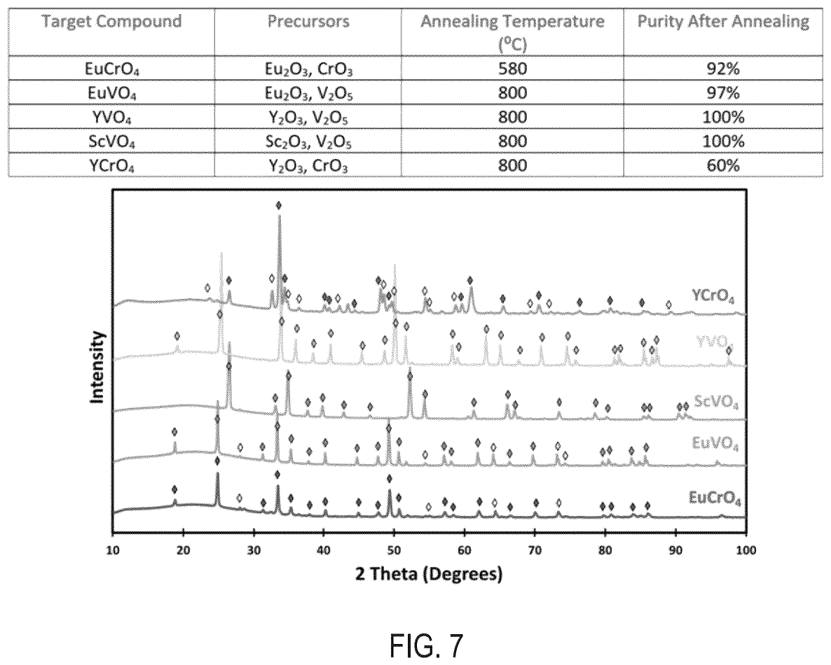

FIG. 7 illustrates an example of five different compositions that were tried with solid-state synthesis, four of which were synthesized with high purity. In the example, precursors were mixed, then pellets were prepared, then they were annealed for 24 hours.

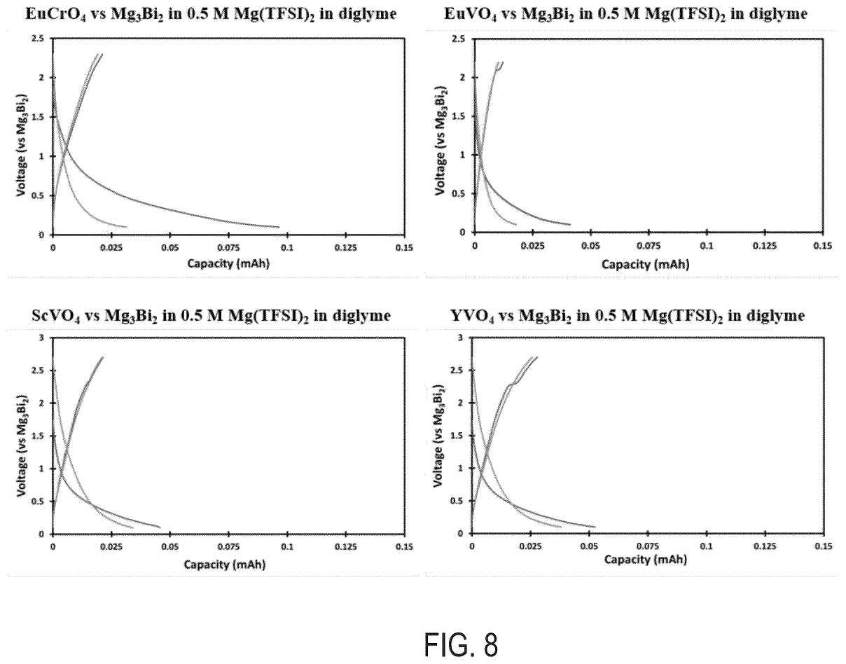

FIG. 8 illustrates an example of electrochemical response of Zircon compounds observed in Mg ion batteries.

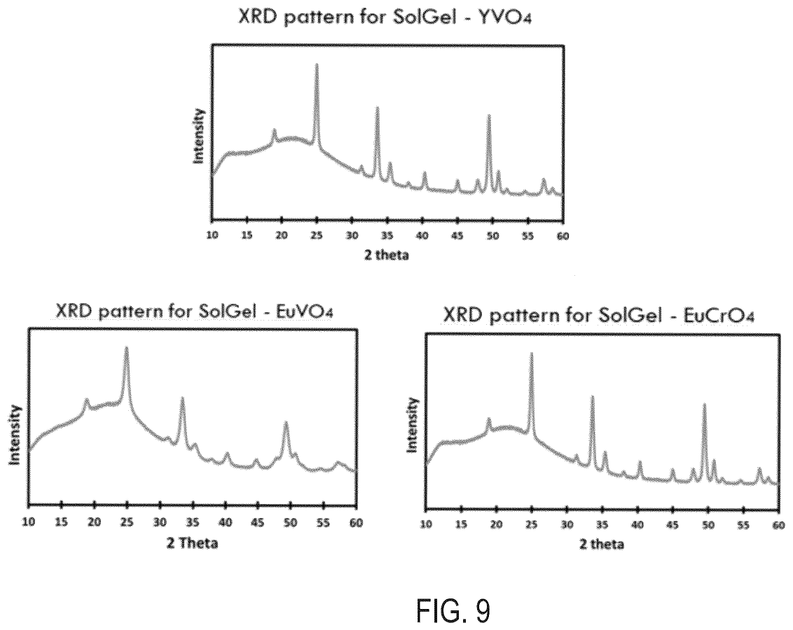

FIG. 9 illustrates an example of three compositions synthesized with sol-gel method.

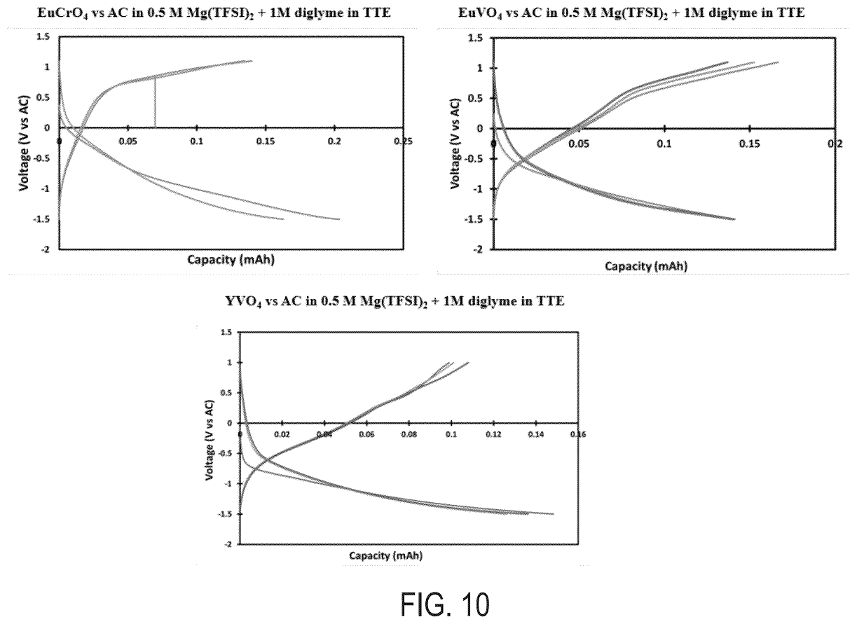

FIG. 10 illustrates an example of electrochemical response of Zircon compounds observed in Mg ion batteries.

### A First Example: Preparation of EuCrO₄ Cathode for Electrochemical Measurements

In an initial step, 140 mg of EuCrO₄ powder is mixed with 40 mg of conductive Carbon are placed into ball mill jars inside the glovebox (under Argon atmosphere).

In a next step, the powders are mixed with planetary ball milling for 3 hours at 300 rpm.

In a next step, after ball milling, the mixture is transferred back to the glovebox and 20 mg of polytetrafluoroethylene (PTFE) is added to the mixture. By this way the overall composition of the cathode film is determined as EuCro₄:C:PTFE=70:20:10.

In a next step, PTFE added powders are mixed for at least 30 minutes in the glovebox with the help of mortar and pestle.

In a next step, the new mixture is rolled for several times (e.g., 8-10) in a stainless-steel plate to obtain a complete polymerization of the binder and homogeneous distribution of all the ingredients.

In a next step, after obtaining a homogeneous cathode film, rolling is continued to decrease the film thickness and circular samples with 1 cm² surface area are punched out from the film.

In a next step, the weight of the circular sample is measured. Then, the sample is rolled again to decrease the thickness of the cathode film. The rolling and punching processes are repeated until the weight of the circular sample becomes 3 mg.

In a next step, after obtaining a sample with 3 mg weight and 1 cm² surface area, the cathode film is placed into the 2-electrode coin cell and electrochemical performance against Mg₃Bi₂ anode in 0.5 M Mg (TFSI)2 in diglyme is tested.

### Second Example: Preparation of EuVO₄ Cathode for Electrochemical Measurements

In an initial step, 140 mg of EuVO₄ powder is mixed with 40 mg of conductive Carbon are placed into ball mill jars inside the glovebox (under Argon atmosphere).

In a next step, the powders are mixed with planetary ball milling for 3 hours at 300 rpm.

In a next step, after ball milling, the mixture is transferred back to the glovebox and 20 mg of polytetrafluoroethylene (PTFE) is added to the mixture. By this way the overall composition of the cathode film is determined as EuVO₄:C:PTFE=70:20:10.

In a next step, PTFE added powders are mixed for at least 30 minutes in the glovebox with the help of mortar and pestle.

In a next step, the new mixture is rolled for several times (8-10) in a stainless-steel plate to obtain a complete polymerization of the binder and homogeneous distribution of all the ingredients.

In a next step, after obtaining a homogeneous cathode film, rolling is continued to decrease the film thickness and circular samples with 1 cm² surface area are punched out from the film.

In a next step, the weight of the circular sample is measured. Then, the sample is rolled again to decrease the thickness of the cathode film. The rolling and punching processes are repeated until the weight of the circular sample becomes 3 mg.

In a next step, after obtaining a sample with 3 mg weight and 1 cm² surface area, the cathode film is placed into the 2-electrode coin cell and electrochemical performance against Mg₃Bi₂ anode in 0.5 M Mg (TFSI)2 in diglyme is tested.

### A Third Example: Preparation of YVO₄ Cathode for Electrochemical Measurements

In an initial step, 140 mg of YVO₄ powder is mixed with 40 mg of conductive Carbon are placed into ball mill jars inside the glovebox (under Argon atmosphere).

In a next step, the powders are mixed with planetary ball milling for 3 hours at 300 rpm.

In a next step, after ball milling, the mixture is transferred back to the glovebox and 20 mg of polytetrafluoroethylene (PTFE) is added to the mixture. By this way the overall composition of the cathode film is determined as YVO₄:C:PTFE=70:20:10.

In a next step, PTFE added powders are mixed for at least 30 minutes in the glovebox with the help of mortar and pestle.

In a next step, the new mixture is rolled for several times (e.g., 8-10) in a stainless-steel plate to obtain a complete polymerization of the binder and homogeneous distribution of all the ingredients.

In a next step, after obtaining a homogeneous cathode film, rolling is continued to decrease the film thickness and circular samples with 1 cm² surface area are punched out from the film.

In a next step, the weight of the circular sample is measured. Then, the sample is rolled again to decrease the thickness of the cathode film. The rolling and punching processes are repeated until the weight of the circular sample becomes 3 mg.

In a next step, after obtaining a sample with 3 mg weight and 1 cm² surface area, the cathode film is placed into the 2-electrode coin cell and electrochemical performance against Mg₃Bi₂ anode in 0.5 M Mg (TFSI)2 in diglyme is tested.

### A Fourth Example: Preparation of ScVO₄ Cathode for Electrochemical Measurements

In an initial step, 140 mg of ScVO₄ powder is mixed with 40 mg of conductive Carbon are placed into ball mill jars inside the glovebox (under Argon atmosphere).

In a next step, the powders are mixed with planetary ball milling for 3 hours at 300 rpm.

In a next step, after ball milling, the mixture is transferred back to the glovebox and 20 mg of polytetrafluoroethylene. (PTFE) is added to the mixture. By this way the overall composition of the cathode film is determined as ScVO₄:C:PTFE=70:20:10.

In a next step, PTFE added powders are mixed for at least 30 minutes in the glovebox with the help of mortar and pestle.

In a next step, the new mixture is rolled for several times (e.g., 8-10) in a stainless-steel plate to obtain a complete polymerization of the binder and homogeneous distribution of all the ingredients.

In a next step, after obtaining a homogeneous cathode film, rolling is continued to decrease the film thickness and circular samples with 1 cm² surface area are punched out from the film.

In a next step, the weight of the circular sample is measured. Then, the sample is rolled again to decrease the thickness of the cathode film. The rolling and punching processes are repeated until the weight of the circular sample becomes 3 mg.

In a next step, after obtaining a sample with 3 mg weight and 1 cm² surface area, the cathode film is placed into the 2-electrode coin cell and electrochemical performance against Mg₃Bi₂ anode in 0.5 M Mg (TFSI)2 in diglyme is tested.

### A Fifth Example: Preparation of EuVO₄ Cathode for Electrochemical Measurements

In an initial step, 140 mg of EuVO₄ powder is mixed with 40 mg of conductive Carbon are placed into ball mill jars inside the glovebox (under Argon atmosphere).

In a next step, the powders are mixed with planetary ball milling for 3 hours at 300 rpm.

In a next step, after ball milling, the mixture is transferred back to the glovebox and 20 mg of polytetrafluoroethylene (PTFE) is added to the mixture. By this way the overall composition of the cathode film is determined as EuVO₄:C:PTFE=70:20:10.

In a next step, PTFE added powders are mixed for at least 30 minutes in the glovebox with the help of mortar and pestle.

In a next step, the new mixture is rolled for several times (e.g., 8-10) in a stainless-steel plate to obtain a complete polymerization of the binder and homogeneous distribution of all the ingredients.

In a next step, after obtaining a homogeneous cathode film, rolling is continued to decrease the film thickness and circular samples with 1 cm² surface area are punched out from the film.

In a next step, the weight of the circular sample is measured. Then, the sample is rolled again to decrease the thickness of the cathode film. The rolling and punching processes are repeated until the weight of the circular sample becomes 3 mg.

In a next step, after obtaining a sample with 3 mg weight and 1 cm² surface area, the cathode film is placed into the 2-electrode coin cell and electrochemical performance against Activated Carbon anode in 0.5 M Mg (TFSI)2 in diglyme is tested.

### A Sixth Example: Preparation of EuCrO₄ Cathode for Electrochemical Measurements

In an initial step, 140 mg of EuCrO₄ powder is mixed with 40 mg of conductive Carbon are placed into ball mill jars inside the glovebox (under Argon atmosphere).

In a next step, the powders are mixed with planetary ball milling for 3 hours at 300 rpm.

In a next step, after ball milling, the mixture is transferred back to the glovebox and 20 mg of polytetrafluoroethylene (PTFE) is added to the mixture. By this way the overall composition of the cathode film is determined as EuCrO₄:C:PTFE=70:20:10.

In a next step, PTFE added powders are mixed for at least 30 minutes in the glovebox with the help of mortar and pestle.

In a next step, the new mixture is rolled for several times (e.g., 8-10) in a stainless-steel plate to obtain a complete polymerization of the binder and homogeneous distribution of all the ingredients.

In a next step, after obtaining a homogeneous cathode film, rolling is continued to decrease the film thickness and circular samples with 1 cm² surface area are punched out from the film.

In a next step, the weight of the circular sample is measured. Then, the sample is rolled again to decrease the thickness of the cathode film. The rolling and punching processes are repeated until the weight of the circular sample becomes 3 mg.

In a next step, after obtaining a sample with 3 mg weight and 1 cm² surface area, the cathode film is placed into the 2-electrode coin cell and electrochemical performance against Activated Carbon anode in 0.5 M Mg (TFSI)2 in diglyme is tested.

### A Seventh Example: Preparation of YVO₄ Cathode for Electrochemical Measurements

In an initial step, 140 mg of YVO₄ powder is mixed with 40 mg of conductive Carbon are placed into ball mill jars inside the glovebox (under Argon atmosphere).

In a next step, the powders are mixed with planetary ball milling for 3 hours at 300 rpm.

In a next step, after ball milling, the mixture is transferred back to the glovebox and 20 mg of polytetrafluoroethylene (PTFE) is added to the mixture. By this way the overall composition of the cathode film is determined as YVO₄:C:PTFE=70:20:10.

In a next step, PTFE added powders are mixed for at least 30 minutes in the glovebox with the help of mortar and pestle.

In a next step, the new mixture is rolled for several times (e.g., 8-10) in a stainless-steel plate to obtain a complete polymerization of the binder and homogeneous distribution of all the ingredients.

In a next step, after obtaining a homogeneous cathode film, rolling is continued to decrease the film thickness and circular samples with 1 cm² surface area are punched out from the film.

In a next step, the weight of the circular sample is measured. Then, the sample is rolled again to decrease the thickness of the cathode film. The rolling and punching processes are repeated until the weight of the circular sample becomes 3 mg.

In a next step, after obtaining a sample with 3 mg weight and 1 cm² surface area, the cathode film is placed into the 2-electrode coin cell and electrochemical performance against Activated Carbon anode in 0.5 M Mg (TFSI)2 in diglyme is tested.

In certain implementations where the composition ABO₄ is EuCrO₄, the M is Mg and the EuCrO₄ is made using either a solid state method or a sol-gel method.

In certain implementations where the composition ABO₄ is EuVO₄, the M is Mg and the EuVO₄ is made using either a solid state method or a sol-gel method.

In certain implementations where the composition ABO₄ is YVO₄, the M is Mg and the YVO₄ is made using either a solid state method or a sol-gel method.

In certain implementations where the composition ABO₄ is ScVO₄, the M is Mg and the ScVO₄ is made using a solid state method.

In certain implementations, the composition ABO₄ is YCrO₄ and the M is Mg.

In certain implementations where the composition ABO₄ is EuCrO₄, the M is Ca and the EuCrO₄ is made using either a solid state method or a sol-gel method.

In certain implementations where the composition ABO₄ is EuVO₄, the M is Ca and the EuVO₄ is made using either a solid state method or a sol-gel method.

In certain implementations where the composition ABO₄ is YVO₄, the M is Ca and the YVO₄ is made using either a solid state method or a sol-gel method.

In certain implementations where the composition ABO₄ is ScVO₄, the M is Ca and the ScVO₄ is made using a solid state method.

In certain implementations, the composition ABO₄ is YCrO₄ and the M is Ca.

In certain implementations where the composition ABO₄ is EuCrO₄, the M is Na and the EuCrO₄ is made using either a solid state method or a sol-gel method.

In certain implementations where the composition ABO₄ is EuVO₄, the M is Na and the EuVO₄ is made using either a solid state method or a sol-gel method.

In certain implementations where the composition ABO₄ is YVO₄, the M is Na and the YVO₄ is made using either a solid state method or a sol-gel method.

In certain implementations where the composition ABO₄ is ScVO₄, the M is Na and the ScVO₄ is made using a solid state method.

In certain implementations, the composition ABO₄ is YCrO₄ and the M is Na.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A composition MxABO₄, comprising:
a composition ABO₄,
wherein M is selected from the group consisting of: Ca, Mg, and Na,
wherein M is intercalated with ABO₄,
wherein x is greater than or equal to 0,
wherein A includes at least one selected from the group consisting of: Dy, Er, Sm, Nd, Tm, Pr, Gd, Sc, Y, Eu, Ho, Tb, Bi, Lu, La, Yb, Ce, Zr, Hf, Th, U, Ce, In, Tl, Pa, Pu, Ba, Pb, and Sr, wherein B includes at least one selected from the group consisting of: B, P, V, Cr, As, Si, Ge, N, Nb, Mo, Ru, Sb, W, Re, Bi, Mn, Fe, Se, Tc, Sn, and Co,
wherein the composition ABO₄ has a crystal structure with a tetragonal I4_1/amd space group, and
wherein the composition ABO₄ has edge-sharing AO₈ dodecahedral and BO₄ tetrahedral.

2. The composition of claim 1, wherein A is Eu, Y, Yb, Sc, or a combination thereof.

3. The composition of claim 1, wherein B is Cr.

4. The composition of claim 1, wherein B is V.

5. The composition of claim 1, wherein the composition ABO₄ is EuCrO₄ and M is Mg, and the EuCro₄ is made using a solid state method or a sol-gel method.

6. The composition of claim 1, wherein the composition ABO₄ is EuVO₄ and M is Mg, and the EuVO₄ is made using a solid state method or a sol-gel method.

7. The composition of claim 1, wherein the composition ABO₄ is YVO₄ and M is Mg, and the YVO₄ is made using a solid state method or a sol-gel method.

8. The composition of claim 1, wherein the composition ABO₄ is ScVO₄ and M is Mg, and the ScVO₄ is made using a solid state method.

9. The composition of claim 1, wherein the composition ABO₄ is YbVO₄ and M is Mg, and the YbVO₄ is made using a solid state method.

10-12. (canceled)

13. The composition of claim 1, wherein the composition ABO₄ is YCrO₄ and M is Mg.

14. The composition of claim 1, wherein the composition ABO₄ is EuCrO₄ and M is Ca or Na, and the EuCrO₄ is made using a solid state method or a sol-gel method.

15. The composition of claim 1, wherein the composition ABO₄ is EuVO₄ and M is Ca or Na, and the EuVO₄ is made using a solid state method or a sol-gel method.

16. The composition of claim 1, wherein the composition ABO₄ is YVO₄ and M is Ca or Na, and the YVO₄ is made using a solid state method or a sol-gel method.

17. The composition of claim 1, wherein the composition ABO₄ is ScVO₄ and M is Ca or Na, and the ScVO₄ is made using a solid state method.

18. The composition of claim 1, wherein the composition ABO₄ is YbVO₄ and M is Ca, and the YbVO₄ is made using a solid state method.

19-33. (canceled)

34. A cathode including the composition of claim 1.
